(19) United States
(12) Patent Application Publication
(10) Pub. No.: US 2022/0245375 A1
(43) Pub. Date: Aug. 4, 2022

(54) Volumetric Security

(71) Applicants: David Young, Bellevue, WA (US); Terrence Nevins, Bellevue, WA (US); Doug de la Torre, Bellevue, WA (US); Aaron Linne, Bellevue, WA (US)

(72) Inventors: David Young, Bellevue, WA (US); Terrence Nevins, Bellevue, WA (US); Doug de la Torre, Bellevue, WA (US); Aaron Linne, Bellevue, WA (US)

(21) Appl. No.: 17/182,174

(22) Filed: Feb. 22, 2021

Related U.S. Application Data
(60) Provisional application No. 63/143,849, filed on Jan. 30, 2021.

(51) Int. Cl. G06K 9/00; G06F 21/32; G06K 9/20; G06K 9/46

(52) U.S. Cl. CPC G06K 9/00201; G06F 21/32; G06K 9/00362; G06K 9/00926; G06K 9/46; G06K 9/00288; G06K 9/209

(57) ABSTRACT

Disclosed, among other things, is volumetric security, which may provide improved techniques for identifying a subject by receiving inputs from a 3-dimensional (3D), or volumetric, image, a 2-dimensional (2D) image, an audio feed or recording, a biometric scanning system, a password entry system, a location-based technology system such as Global Positioning System (GPS) or interactions between a Bluetooth® beacon and an application on a mobile device, or another data source, comparing the inputs to data stored in one or more databases, assigning weights to the inputs, outputting weighted values, and integrating an algorithm that factors the weighted values to output a subject identifier and a confidence score. The confidence score may define a probability that the identifier correctly identifies a subject.

### FIELD

This disclosure relates generally to systems and methods for volumetric security.

### BACKGROUND

Conventional security systems are routinely compromised, putting millions of people's data and safety at risk. Password-protected systems are easily accessed by hackers using brute force attacks, phishing tactics, malicious software, or other methods. Facial recognition systems fail to accurately identify subjects when minor changes, such as makeup or costumes, are applied to key facial features. There is an urgent need in the marketplace for security systems and methods that provide users greater accuracy and confidence.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, volumetric security, which may provide improved techniques for identifying a subject by performing steps that may include receiving inputs from a plurality of data sources, such as a 3-dimensional (3D) or volumetric video, a 2-dimensional (2D) image, an audio feed or recording, a biometric scanning system, a password entry system, a location-based technology system such as Global Positioning System (GPS) or interactions between a Bluetooth® beacon and an application on a mobile device, or another data source. Volumetric security may perform additional steps of comparing the inputs to data stored in one or more databases, assigning weights to the inputs, and integrating an algorithm that factors in one or more of the weighted values to output a set of parameters, which may include a subject identifier and a confidence score. The confidence score may define a probability that the identifier correctly identifies a particular subject.

In one implementation, volumetric security may be integrated into practical applications of safety or authentication, enhancing the effectiveness of a security system to grant or deny permissions. In another implementation, volumetric security may be integrated into practical applications of law enforcement, targeted marketing, social networking, health care, or another field.

Many of the attendant features may be more readily appreciated as they become better understood by reference to the following detailed description considered in connection with the attached drawings.

### BRIEF DESCRIPTION OF THE DRAWINGS

FIG. 1 is a flow diagram for a volumetric security process, according to one implementation.

FIG. 2 illustrates a block diagram of display screens in a graphical user interface layout for an application or website using a volumetric security system, according to one implementation.

FIG. 3 illustrates a system capable of supporting a volumetric security system, according to one implementation.

FIG. 4 is a component diagram of a computing device that may support a volumetric security system, according to one implementation.

### DETAILED DESCRIPTION

Many of the attendant features may be more readily appreciated as they become better understood by reference to the following detailed description considered in connection with the attached drawings, in which like parts are assigned like numerals.

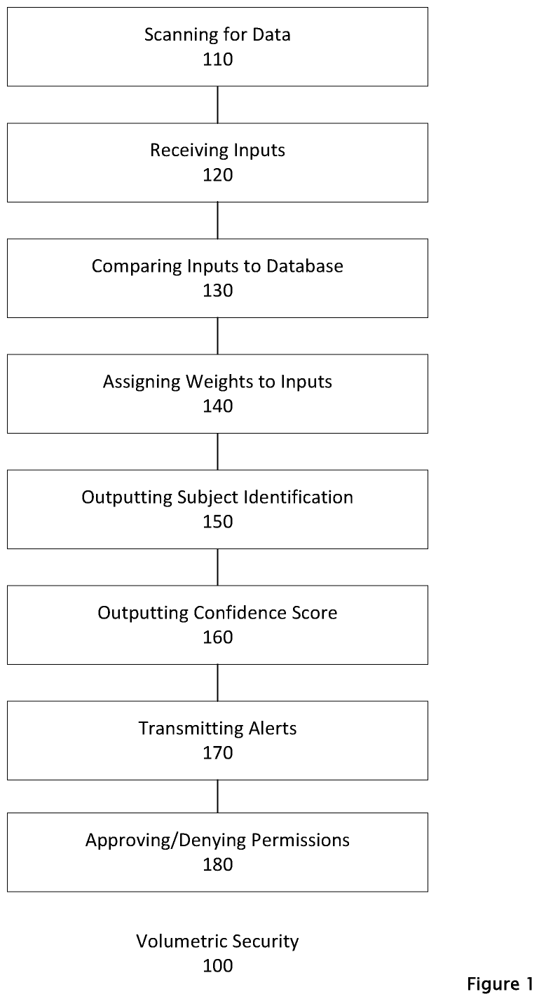

FIG. 1 is a flow diagram for a volumetric security process, according to one implementation. Various implementations of volumetric security techniques may include computer-readable storage media containing sets of instructions to cause one or more processors to perform methods, variations of the methods, and other operations described herein.

Volumetric Security 100 may provide improved techniques for accurately identifying a subject. At Scanning for Data 110, the Volumetric Security 100 system may scan a lobby, a crowd, or another actual or virtual space for data. At Receiving Inputs 120, the Volumetric Security 100 system may receive data from sources that may include 3-dimensional (3D) or volumetric imaging. The volumetric imaging may utilize methods that do not rely on the visible light spectrum, for example, infrared or thermal imaging, light detection and ranging (LiDAR) imaging, which may use ultraviolet, visible, or near-infrared (NIR) light, or other techniques. The inputs received from the volumetric images may provide detailed information related to a subject's physical characteristics, attitudes, or behaviors that may be difficult or impossible to obtain using 2D imaging or other techniques. For example, a volumetric video may yield inputs that detail a depth of a nose, a posture position, a walking pattern, a fluidity of movement, a steadiness of a hand, a length or intensity of a gaze, which may utilize Pupil Center Corneal Reflection (PCCR) eye-tracking or other techniques, 3D dimensions of a concealed object, which may correlate with dimensions of a particular weapon model or other data. In another implementation, the system may use Wi-Fi or a backscatter radio frequency (RF) radar to obtain gross or detailed physical dimensions or other characteristics of a subject, for example.

Volumetric Security 100 system may couple the data inputs from the volumetric imaging with data inputs from additional sources, which may include 2-dimensional (2D) imaging, an audio live feed or recording, a biometric sensor, a password entry system, a location-based technology system such as Global Positioning System (GPS), interactions between a Bluetooth® beacon and an application on a mobile device, or another data source. Data inputs received from the 2D imaging may comprise measurements between landmarks, or nodal points, on a subject's face or another surface. In one implementation, the Volumetric Security 100 system may listen for keywords or transmit warnings upon recognizing a sound or a song, and it may match beamforming of a microphone to identify a speaker, for example.

Data inputs received from the biometric sensor may indicate a measurement of light, temperature, speed, electric capacity, or another type of energy, which may facilitate a reading of a fingerprint or an iris, for example. A password entry system may provide a unique identifier, which may include an alphanumeric or special character code, a static or dynamic barcode, or another type of passcode. Interactions between a Bluetooth® beacon and an application on a mobile device may provide information related to, for example, a subject's arrival or departure at a location.

At Comparing Inputs to Database 130, the Volumetric Security 100 system may compare the data inputs received to data stored in one or more databases, for example, a facial recognition database, a voice recognition database, a membership database, an employee database, a criminal database, a medical records database, or a marketing database, for example.

At Assigning Weights to Inputs 140, the Volumetric Security 100 system may assign a weight to a data input, or a set of data inputs, based on a history of accurate identification of a subject, for example, and the system may output a weighted value. In another implementation, the weights may be based on other factors, for example, socio-economic data or geographical data.

At Outputting Subject Identification 150, the system may integrate an algorithm that factors in one or more of the weighted values to output a set of parameters, which may include a subject identifier, for example, a name. The subject may comprise a human being, a living or non-living thing, an event, for example, or a set of subjects. In one implementation, the Volumetric Security 100 system may display a list of registered subjects and identification attributes, enable deletion of a registered subject, or enable registration of a new subject. The system may de-personalize the data. For example, it may designate subjects as Person A or Person B, or it may provide an estimated age or another characteristic of a subject.

At Outputting Confidence Score 160, the system may output a probability that the identifier correctly identifies a particular subject. Volumetric Security 100 system may confine certain permissions to subjects with a 95%, a 98%, or another confidence score, for example. The Volumetric Security 100 system may be adaptive. For example, it may learn that a subject or its surroundings have undergone a change, and the system may factor that change into future identification of the subject or other subjects. The system may apply layers of feedback. For example, it may log data related to a subject that has been flagged, and this data may be used to train the system to improve to provide more accurate results. Volumetric Security 100 may integrate machine learning to improve identification accuracy and decrease chances for false positives.

Volumetric Security 100 may be integrated into practical applications of safety and surveillance, enhancing the effectiveness of a security system to Approve or Deny Permissions 180. In another implementation, Volumetric Security may be integrated into practical applications of health management, commercial or non-commercial marketing, or any other field. Volumetric Security 100 system may provide early insights into characteristics, attitudes, behaviors, or events and enable improved services, among other benefits.

The Volumetric Security 100 system may enable an alert when a subject is identified. At Transmitting Alerts 170, the system may send an alert to an administrator, to a concierge, to an employer, to a law enforcement agency, to the public, or to another authorized recipient. In one implementation, the system may integrate a web-based service that enables apps and smart devices to communicate with one another, for example, using applets to define triggers to execute an action.

In one implementation, the Volumetric Security 100 system may utilize machine learning to train the system to look for dimensions, or other data, particular to a subject or a group of subjects. For example, if Volumetric Security 100 system determines that a new or unrecognized visitor enters a lobby, the system may transmit an alert to a concierge. Information collected from any subject may be integrated into a database, enabling the system to utilize machine learning to train, update, or improve the system to ensure a higher level of accuracy in identifying subjects.

In one implementation, Volumetric Security 100 may utilize a platform for desktop personal computers (PCs), or another device, such as a mobile phone, with internet connectivity. A person skilled in the art will understand that various languages, containers, or technology stacks may be used.

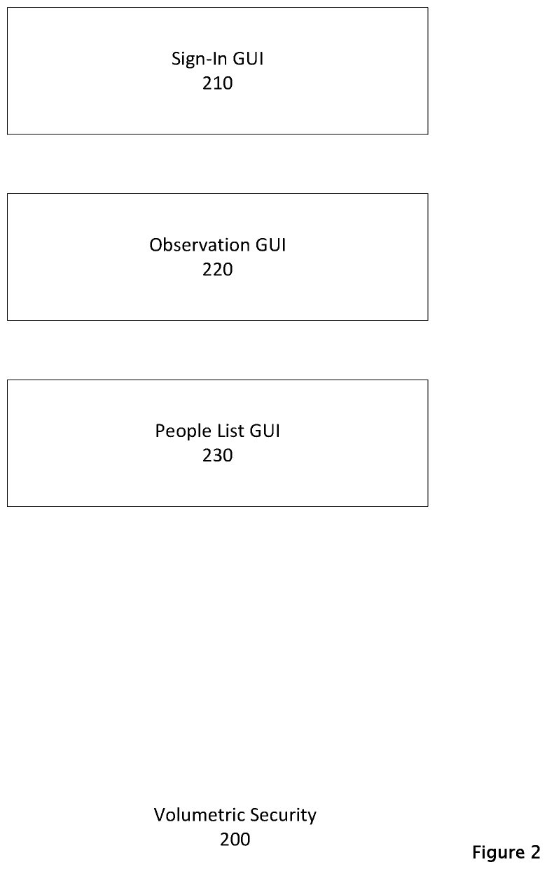

FIG. 2 illustrates a block diagram of display screens in a graphical user interface (GUI) layout for an application or website using a Volumetric Security 200 system, according to one implementation. In one implementation, Sign-In GUI 210 may comprise a sign-in screen of tenants, for example, a developer or an end-user. A user experience (UX) audience may comprise a facility concierge, a company staff member, a law enforcement agency, or a commercial or non-commercial entity, for example. Observation GUI 220 may comprise an option to select a camera feed, which may include a special designation for volumetric-enabled feeds.

Observation GUI 220 may comprise a 2D camera feed, which may utilize a web-based cognitive service, and which may draw boxes on a subject's face or display a subject name with boxes. Observation GUI 220 may comprise a volumetric feed, which may utilize a web-based cognitive service, and which may draw boxes on a subject's face, draw facial markers on a subject's face, display a subject name with boxes, or draw the subject's skeleton. Observation GUI 220 may comprise an event list that may display a list of new subjects identified, for example, an identifier, a name, a time first observed, or a time disappeared. The event list may display a confidence score for 2D recognition, for example, a current, minimum, or maximum score. The event list may also display a confidence score for volumetric facial recognition or for volumetric body recognition, for example, a current, minimum, or maximum score for each. Observation GUI 220 may also display a new observation alert.

People List GUI 230 may display a list of observed people, for example, an identifier, a name, or a last observation. The people list may display details of a specific person, for example, an identifier, a name, a last observation, a registered picture, a skeletal model or measurement, or an observation history, such as a time of observation, a maximum confidence score during observation, or a time disappeared.

Volumetric Security 100 may identify a subject even in the absence of a 2D facial scan or other data. Volumetric Security 100 may identify a subject even if a confidence score of certain types of data is low or moderate, for example, if an overall confidence score meets a threshold. Volumetric Security 100 may factor a plurality of variables, including information possessed by the subject, information known by the subject, identifying features of the subject, or data from another source.

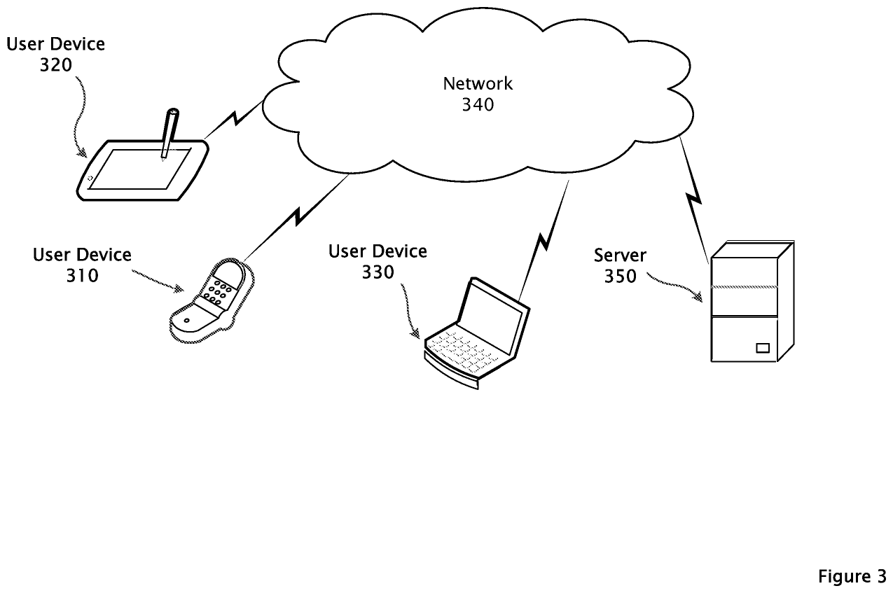

FIG. 3 is a block diagram illustrating an example of a system capable of supporting a Volumetric Security 100 system, according to one implementation. Network 340 may include Wi-Fi, cellular data access methods, such as 3G or 4GLTE, Bluetooth®, Near Field Communications (NFC), the internet, local area networks, wide area networks, or any combination of these or other means of providing data transfer capabilities. In one implementation, Network 340 may comprise Ethernet connectivity. In another implementation, Network 340 may comprise fiber-optic connections.

User Device 310, 320, or 330 may be a smartphone, tablet, laptop computer, smartwatch or intelligent eyewear, or other device, and may have location-based services, for example, GPS, cell phone tower triangulation capability, or accelerometers, and may have network capabilities to communicate with Server 350. Server 350 may include one or more computers and may serve a number of roles. Server 350 may be conventionally constructed or may be of a special purpose design for processing data obtained from a Volumetric Security 100 system. One skilled in the art will recognize that Server 350 may be of many different designs and may have different capabilities.

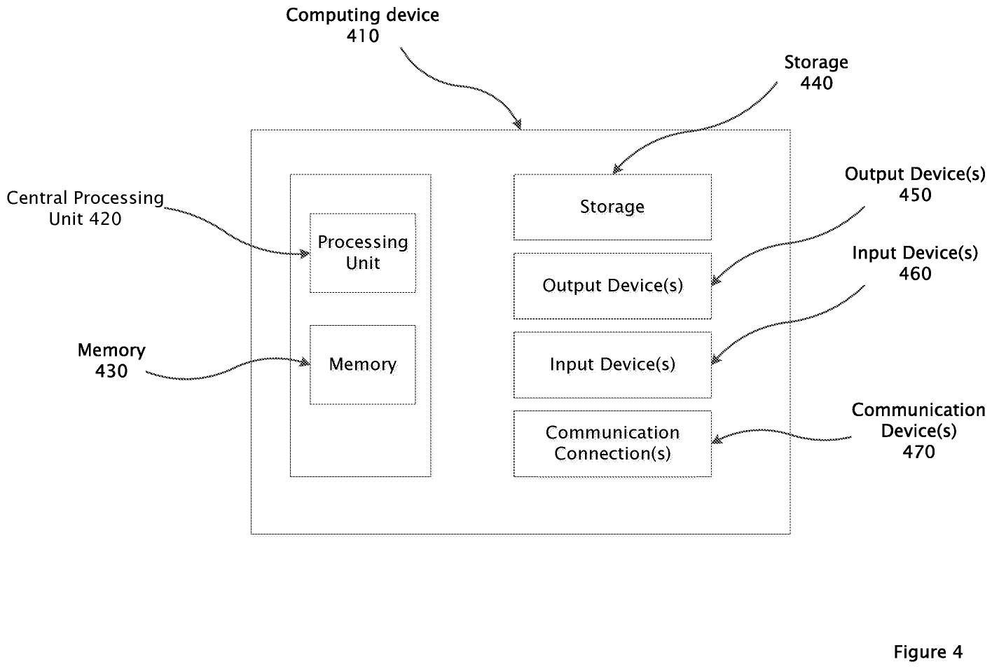

FIG. 4 is a component diagram of Computing Device 410, that may support a Volumetric Security 100 system, according to one implementation. Computing Device 410 can be utilized to implement one or more computing devices, computer processes, or software modules described herein, including, for example, but not limited to a mobile device. In one example, Computing Device 410 can be used to process calculations, execute instructions, and receive and transmit digital signals. In another example, Computing Device 410 can be utilized to process calculations, execute instructions, receive and transmit digital signals, receive and transmit search queries and hypertext, and compile computer code suitable for a mobile device. Computing Device 410 can be any general or special purpose computer now known or to become known capable of performing the steps or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), nonvolatile (such as ROM, flash memory, etc.), or some combination of the two. Additionally, Computing Device 410 may also have additional features/functionality. For example, Computing Device 410 may include multiple CPUs. The described methods may be executed in any manner by any processing unit in Computing Device 410. For example, the described process may be executed by both multiple CPUs in parallel.

Computing Device 410 may also include additional storage (removable or non-removable) including, but not limited to, magnetic or optical disks or tape. Such additional storage is illustrated by Storage 440. Computer-readable storage media includes volatile and nonvolatile, removable and non-removable media implemented in any method or technology for storage of information such as computer-readable instructions, data structures, program modules, or other data. Memory 430 and Storage 440 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage, or other magnetic storage devices, or any other medium which can be used to store the desired information and which can be accessed by Computing Device 410. Any such computer-readable storage media may be part of Computing Device 410. But computer-readable storage media does not include transient signals.

Computing Device 410 may also contain Communications Device(s) 470 that allow the device to communicate with other devices. Communications Device(s) 470 is an example of communication media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media as used herein includes both computer-readable storage media and communication media. The described methods may be encoded in any computer-readable media in any form, such as data, computer-executable instructions, and the like.

Computing Device 410 may also have Input Device(s) 460, such as keyboard, mouse, pen, voice input device, touch input device, etc. Output Device(s) 450 such as a display, speakers, printer, etc., may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show certain events occurring in a certain order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

The foregoing description of various implementations of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many implementations of the invention can be made without departing from the spirit and scope of the invention, the invention resides in the claims hereinafter appended.

1. A method for identifying a person comprising:
scanning an environment for data to select a subject;
using volumetric imaging to collect information about the subject;
determining specific physical characteristics of the subject based on the volumetric imaging; and
using the specific physical characteristics to identify the subject.

2. The method of claim 1 wherein the volumetric imaging comprises using thermal imaging.

3. The method of claim 1 further comprising using two-dimensional imaging in addition to volumetric imaging to determine specific physical characteristics of the subject.

4. The method of claim 1 further comprising determining a confidence score for the identification of the subject.
